(19) United States
(12) Patent Application Publication
(10) Pub. No.: US 2007/0135938 A1
(43) Pub. Date: Jun. 14, 2007

(54) Methods and systems for predictive modeling using a committee of models

(75) Inventors: Rajesh Venkat Subbu, Clifton Park, NY (US); Piero Patrone Bonissone, Schenectady, NY (US); Feng Xue, Clifton Park, NY (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/297,034

(22) Filed: Dec. 8, 2005

(51) Int. Cl. G05B 13/02

(52) U.S. Cl. 700/30

(57) ABSTRACT

Methods and systems for predictive modeling are described. In one embodiment, the method is a method for controlling a process using a committee of predictive models. The process has a plurality of control settings and at least one probe data representative of state of the process. The method includes the steps of providing probe data to each model in the model committee so that each model generates a respective output, aggregating the model outputs, and generating a predictive output based on the aggregating.

### BACKGROUND OF THE INVENTION

This invention relates generally to predictive modeling and more particularly, to predictive modeling utilizing a committee of models and fusion with locally weighted learning.

Many different approaches have been utilized to optimize asset utilization. For example, asset optimization can be performed in connection with operation of a turbine or boiler for generating electricity supplied to a power grid. It is useful to predict and optimize for parameters such as Heat rate, NOx emissions, and plant load under various operating conditions, in order to identify a most optimum utilization of the turbine or the boiler.

Predictive modeling of an asset to be optimized is one known technique utilized in connection with decision-making for asset optimization. With a typical predictive model, however, local performance can vary over the prediction space. For example, a particular predictive model may provide very accurate results under one set of operating conditions, but may provide less accurate results under another set of operating condition.

Such prediction uncertainty can be caused by a wide variety of factors. For example, data provided to the model under certain conditions may contain noise, which leads to inaccuracy. Further, model parameter misspecification can result due to data-density variations in operating mode representation in the training set data, variations resulting from randomly sampling the training set data, non-deterministic training results, and different initial conditions. Also, model structure misspecification can occur if, for example, there are insufficient neurons in a neural network predictive model or if regression models are not specified with sufficient accuracy.

### BRIEF DESCRIPTION OF THE INVENTION

In one aspect, a method for controlling a process using a committee of predictive models is provided. The process has a plurality of control settings and at least one probe for generating data representative of state of the process. The method includes the steps of providing probe data to each model in the model committee so that each model generates a respective output, aggregating the model outputs, and generating a predictive output based on the aggregating.

In another aspect, a system for generating a predictive output related to a process is provided. The process has a plurality of control settings and at least one probe for generating data representative of state of the process. The system includes a committee of models comprising a plurality of predictive models. Each model is configured to generate a respective output based on data from the probe. The system includes a computer programmed to fuse the outputs from the models to generate at least one predictive output based on the model outputs.

In yet other aspect, a computer implemented method for generating a predictive output related to a process is provided. The process has a plurality of control settings and at least one probe for generating data representative of state of the process. The method includes supplying inputs to a committee of models comprising a plurality of predictive models, executing each model to generate a respective output based on data from the probe, and fusing the outputs from the models to generate at least one predictive output based on the model outputs.

### BRIEF DESCRIPTION OF THE DRAWINGS

FIG. 1 is a schematic illustration of utilizing a committee of models and fusion to predict performance of a probe.

FIG. 2 illustrates training of multiple predictive models.

FIG. 3 illustrates retrieval of peers of a probe.

FIG. 4 illustrates evaluation of the local performance of predictive models.

FIG. 5 illustrates model aggregation and bias compensation.

### DETAILED DESCRIPTION OF THE INVENTION

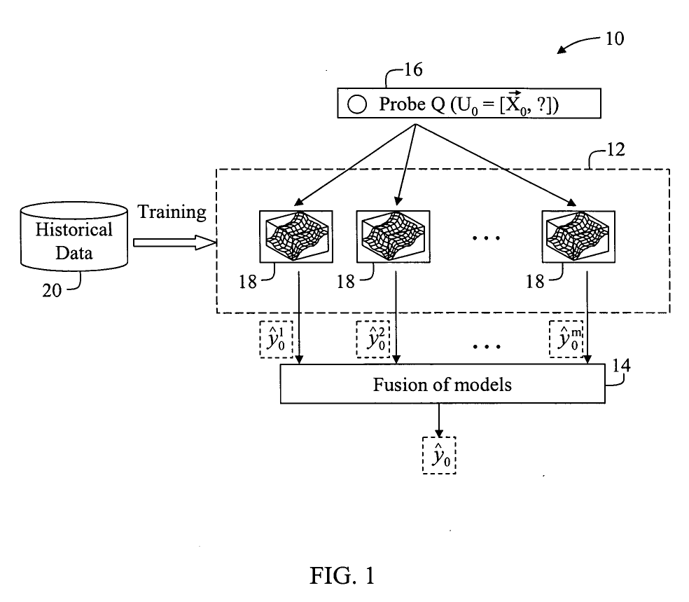

FIG. 1 is a schematic illustration of utilizing a system 10 for generating a predictive output utilizing a committee of models 12 and fusion 14. In the example illustrated in FIG. 1, system 10 is utilized in connection with predicting an output from a probe 16. As used herein, the term “model” generally refers to, but is not limited to referring to, a predictive module that can serve as a proxy for the underlying asset/system performance representation, and the term “committee” refers to, but is not limited to referring to, a collection or set of models that are each capable of doing a similar, albeit not exact, prediction task. System 10 can, in one embodiment, be implemented within a general-purpose computer. Many different types of computers can be utilized, and the present invention is not limited to practice on any one particular computer. The term “computer”, as used herein, includes desktop and laptop type computers, servers, microprocessor based systems, application specific integrated circuits, and any programmable integrated circuit capable of performing the functions described herein in connection with system.

As shown in FIG. 1, model committee 12 includes multiple predictive models 18. Each predictive model 18 generates a predicted output for Probe Q 16 based on the model input. The model outputs are “fused” 14, as described below in more detail, and system 10 generates one output based on such fusion. The fused output can then be used to evaluate the output of a process corresponding to the control settings represented by the probe. The term “fuse”, as used herein, refers to combining the outputs in a manner that results in generation of a modified output.

In one embodiment, each model 18 is a neural network based data-driven model trained and validated using historical data 20 and constructed to represent input-output relationships, as is well known in the art. For example, for a coal-fired boiler, there may be multiple model committees including multiple models in order to generate outputs representative of the various characteristics of the boiler. Example inputs include the various controllable and observable variables, and the outputs may include emissions characteristics such as NOx and CO, fuel usage characteristics such as heat rate, and operational characteristics such as bearable load.

With respect to FIG. 1, the inputs supplied to each model 18 from Probe Q 16 represent one of the various variables. The term “probe”, as used herein, refers to any type of sensor or other mechanism that generates an output supplied, directly or indirectly, as an input to a predictive model. Examples of such probes include temperature sensors, pressure sensors, flow sensors, position sensors, NOx sensors, CO sensors, and speed sensors. Probe can, of course, be one of many other different types of input to a predictive model, for example, a probe could be generated by an optimizer, or for example, a probe could be known input variables captured in a data set. Each model 18 generates a quantitative representation of a system characteristic based on the input variable.

As explained above, the local performance of each model 18 of committee 12 may vary and may not be uniformly consistent over the entire prediction space. For example, in one particular set of operational conditions, one model 18 may have superior performance relative to the other models 18. In another set of operational conditions, however, a different model 18 may have superior performance and the performance of the one model 18 may be inferior. The outputs from models 18 of committee 12 therefore are, in one embodiment, locally weighted using the process described below in order to leverage the localized information so that models 18 are complementary to each other.

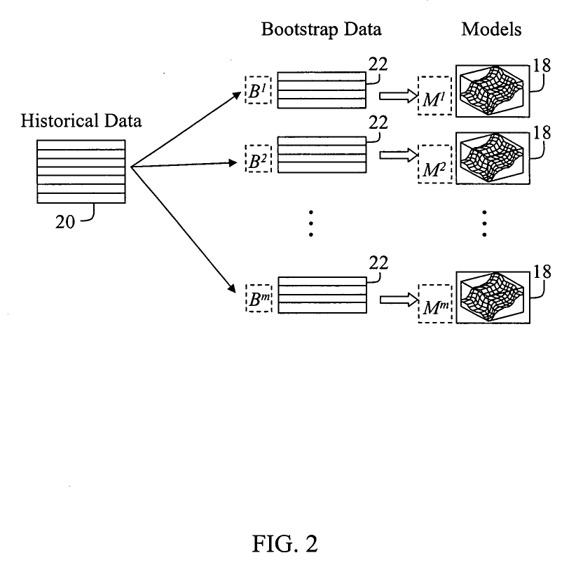

With respect to training multiple models, and referring to FIG. 2, each predictive model 18 is trained using historical data 20, as is well known in the art. Specifically, different but possibly overlapping sets 22 of historical data are provided to each model 18, and such data is “bootstrapped” to train each model 18. That is, bootstrap validation, which is well known in the art, is utilized in connection with training each model 18 based on historical data 20. More specifically, training data sets are created by re-sampling with replacement from the original training set, so data records may occur more than once. Usually final estimates are obtained by taking the average of the estimates from each of the bootstrap test sets.

For example, historical data 20 typically represents known variable inputs and known outputs. During training, the known output is compared with the model-generated output, and if there is a difference between the model generated output and the known output, the model is then adjusted (e.g., by altering the node weighting and/or connectivity for a neural network model) so that the model generates the known output.

Again, and as illustrated in FIG. 2, different but possibly overlapping sets 22 of historical data are utilized in connection with such training. As a result, one model 18 may have particularly superior performance with respect to the variable conditions used in connection with training that model 18. For a different set of variable conditions, however, another model 18 may have superior performance.

Once models 18 are trained and the committee of models 12 is defined, then an algorithm for fusing the model outputs is generated. Many different techniques can be utilized in connection with such fusion, and the present invention is not limited to any one particular fusion technique. Set forth below is one example fusion algorithm.

More particularly, and in the one embodiment with respect to probe 16, a fusion algorithm proceeds by retrieving neighbors/peers of the probe within the prediction inputs space. Local performance of the models is then computed, and multiple predictions are aggregated based on local model performance. Compensation is then performed with respect to the local performance of each model. Compensation may also be performed with respect to the global performance of each model. Such a global performance may be computed by relaxing the neighborhood range for a probe to the entire inputs space. A “fused” output is then generated.

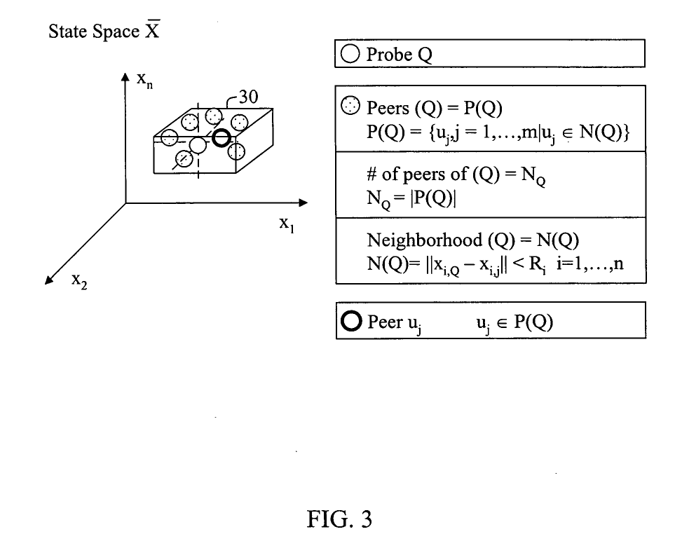

FIG. 3 illustrates retrieval of neighbors/peers within a prediction inputs space 30. More specifically, and with reference to FIG. 3, Probe Q is represented by a solid circle within prediction space 30. The shaded circles represent peers of Probe Q, or Peers (Q), where the number of peers of (Q) is represented by N_{Q}. The neighbors of (Q) are represented by N(Q). A given peer uⱼ is represented by a shaded circle with a thick solid outline.

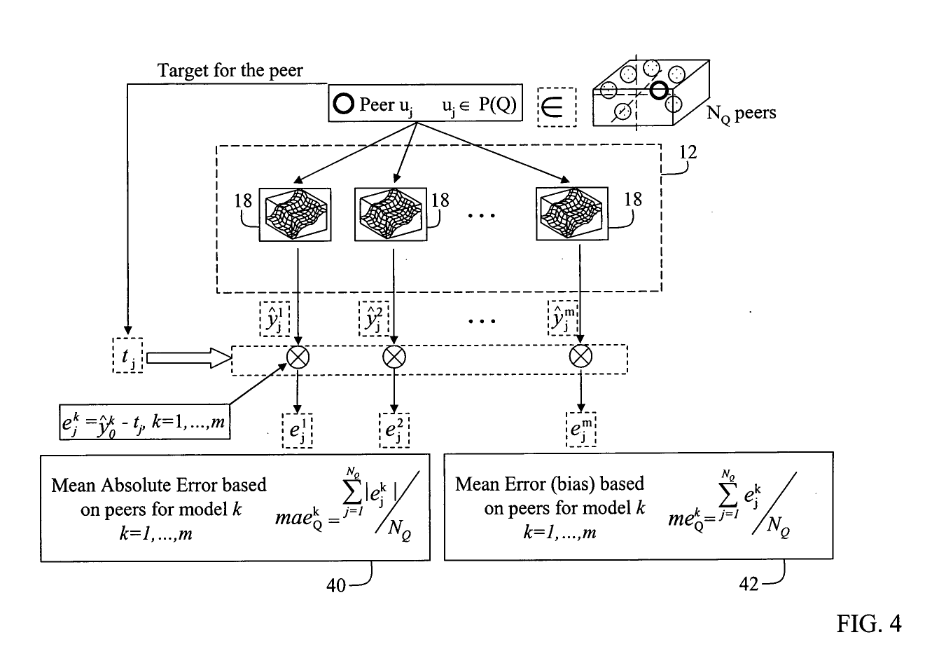

Once the neighbors/peers of Probe Q are retrieved, then the local performance of each model for such neighbors/peers is evaluated, as shown in FIG. 4. Specifically, FIG. 4 illustrates evaluation of the local performance of predictive models 18. As shown in FIG. 4, a mean absolute error 40 and a mean error (bias) 42 are determined for each model 18. A local weight for each model is based on the mean absolute error on peers for that model.

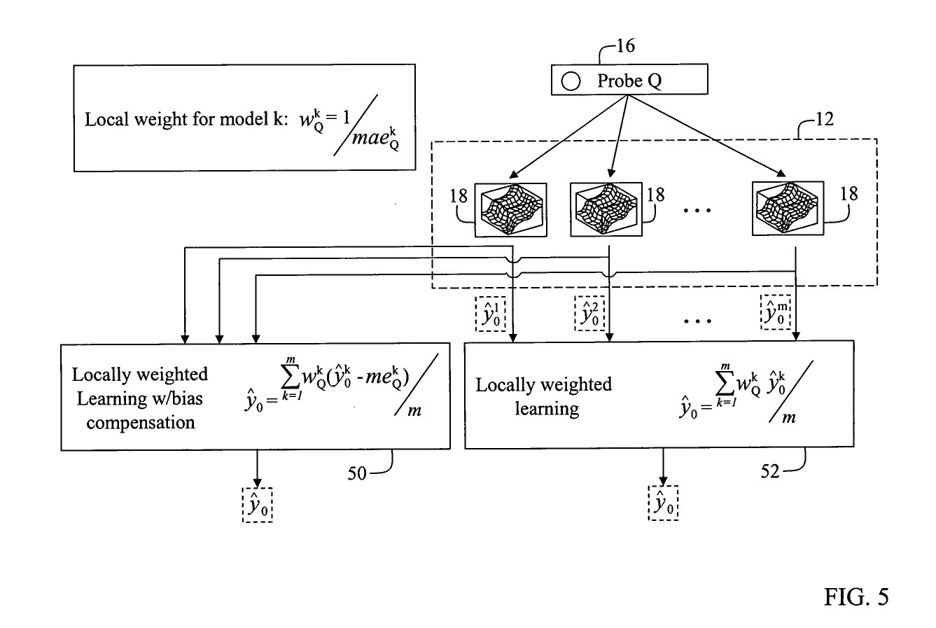

FIG. 5 illustrates model aggregation and bias compensation. Specifically, an output from each model 18 is supplied to an algorithm for local weighting learning with bias compensation 50 and to an algorithm for local weighted learning with no bias compensation 52. If bias compensation is desired, then an output from model with bias compensation can be utilized. As explained above, the local weight for each model is based on the mean absolute error based on peers for that model. If bias compensation is not desired, then an output from model with no bias compensation can be utilized.

Through aggregation and bias compensation, the outputs of the committee of models are fused to generate one output. Use of a committee of models facilitates boosting prediction performance. By decreasing uncertainty in predictions through use of a committee of models and fusion, an aggressive schedule can be deployed in an industrial application as compared to predictions based on one model only. In addition, use of a committee of models and fusion facilitates using a reduced amount of historical data as compared to the historical data used to train systems based on just one model, which facilitates accelerating system deployment.

While the invention has been described in terms of various specific embodiments, those skilled in the art will recognize that the invention can be practiced with modification within the spirit and scope of the claims.

1. A method for controlling a process using a committee of predictive models, the process having a plurality of control settings and at least one probe data representative of state of the process, said method comprising the steps of:
providing probe data of the at least one probe within a prediction inputs space to each model in the model committee so that each model generates a respective output;
retrieving peers of the at least one probe, wherein the peers are within the prediction inputs space;
determining a local performance of each model by calculating outputs from each model for each peer;
aggregating the model outputs;
generating a predictive output based on said aggregating; and
transmitting the predictive output for viewing by an operator.

2. A method in accordance with claim 1 wherein each model is a neural network based data-driven model.

3. A method in accordance with claim 2 wherein each model is trained and validated using historical operational data.

4. A method in accordance with claim 1 wherein each model represents an input-output relationship.

5. A method in accordance with claim 1 wherein aggregating the model outputs comprising compensating each model output based on model performance.

6. A method in accordance with claim 5 wherein compensating is performed using at least one of:
a local weight determined for each model; and
a local weight and bias determined for each model.

7. A method in accordance with claim 6 wherein the local weight for each model is based on a mean absolute error determined using peers for each model.

8. A system for generating a predictive output related to a process, the process having a plurality of control settings and at least one probe data representative of state of the process, said system comprising:
a committee of models comprising a plurality of predictive models, each said model configured to generate a respective output based on data from a probe within a prediction inputs space; and
a computer programmed to:
retrieve peers of the probe wherein the peers are within the prediction inputs space:
determine a local performance of each model by calculating outputs from each model for each peer;
fuse the outputs from said models to generate at least one predictive output based on said model outputs; and
transmit the at least one predictive output for viewing by an operator.

9. A system in accordance with claim 8 wherein each said model is a neural network based data-driven model.

10. A system in accordance with claim 9 wherein each model is trained and validated using historical operational data.

11. A system in accordance with claim 8 wherein each model represents an input-output relationship.

12. A system in accordance with claim 8 wherein to fuse the outputs from said models, some computer is programmed to aggregate the model outputs, and generate a predictive output based on said aggregating.

13. A system in accordance with claim 12 wherein said aggregating the model outputs comprises compensating each model output based on model performance.

14. A system in accordance with claim 13 wherein said compensating is performed using at least one of:
a local weight determined for each model; and
a local weight and bias determined for each model.

15. A system in accordance with claim 14 wherein the local weight for each said model is based on a mean absolute error determined using peers for each model.

16. A computer implemented method for generating a predictive output related to a process, the process having a plurality of control settings and at least one probe data representative of state of the process, said method comprising:
supplying inputs to a committee of models comprising a plurality of predictive models;
executing each said model to generate a respective output based on data from the probe within a prediction inputs space;
retrieving peers of the probe, wherein the peers are within the prediction inputs space;
determining a local performance of each model by calculating outputs from each model for each peer;
fusing the outputs from said models to generate at least one predictive output based on said model outputs; and
transmitting the at least one predictive output for viewing by an operator.

17. A computer implemented method in accordance with claim 16 wherein each said model is a neural network based data-driven model, each said model representing an input-output relationship.

18. A computer implemented method in accordance with claim 16 wherein to fuse the outputs from said models, said method comprises aggregating the model outputs and generating a predictive output based on said aggregating.

19. A computer implemented method in accordance with claim 18 wherein said aggregating the model outputs comprises compensating each model output based on model performance.

20. A computer implemented method in accordance with claim 19 wherein said compensating is performed using at least one of:
a local weight determined for each model; and
a local weight and bias determined for each model.
